(19) United States
(12) Patent Application Publication
(10) Pub. No.: US 2009/0055288 A1
(43) Pub. Date: Feb. 26, 2009

(54) DIGITAL CONTENT FILE RESALE AND PURCHASE SYSTEM AND METHOD

(76) Inventor: Shary Nassimi, Malibu, CA (US)

Correspondence Address: BOND, SCHOENECK & KING, PLLC, ONE LINCOLN CENTER, SYRACUSE, NY, 13202-1355, US

(21) Appl. No.: 12/263,839

(22) Filed: Nov. 3, 2008

Related U.S. Application Data
(63) Continuation-in-part of application No. 12/123,565, filed on May 20, 2008.
(60) Provisional application No. 60/939,162, filed on May 21, 2007.

(51) Int. Cl. G06Q 30/00; G06F 17/30; G06Q 20/00; G06Q 50/00

(52) U.S. Cl. 705/26; 707/10; 707/E17.01; 707/E17.111

(57) ABSTRACT

A system and method for allowing the owners of digital content files to resell or purchased used content. The system provides for access via the internet 23 and allows a user to upload or download content. To ensure against illicit copying of content, the system preferably includes a verification software package that must be downloaded onto the digital player device from which the user is attempting to resell content. The digital content files uploaded to system are then made available for repurchase by another user. When the digital content file is resold to another user, the digital content file is removed from the available content list so that only the original digital content file is ever transferred from one user to another user.

### CROSS-REFERENCE TO RELATED APPLICATIONS

The present application is a continuation-in-part of U.S. patent application Ser. No. 12/123,565, filed May 20, 2008. U.S. patent application Ser. No. 12/123,565 is an application claiming the benefit under 35 USC Section 119(e) of U.S. Provisional Patent Application Ser. No. 60/939,162, filed May 21, 2007. The present application is based on and claims priority from these applications, the disclosures of which are hereby expressly incorporated herein by reference.

### BACKGROUND OF THE INVENTION

1. Field of the Invention

The present invention relates to downloadable digital content files and, more specifically, to a system and method for reselling and purchasing downloadable digital content files.

2. Description of the Related Art

With the advent of the internet and availability of audio and audiovisual content in digital formats, users are able to purchase or license digital content files containing their favorite music, spoken word recordings, movies, television shows, and other audio and audiovisual content. Audio and audio visual content, as well as other types of “digital content” (e.g. software and databases), can be downloaded from the internet as “digital content files” or “downloadable digital content files.” The digital content files may be stored, executed, accessed, viewed, and/or played (hereinafter, “digitally utilized”) in “digital player devices.” Digital player devices include, for example, desktop computers, laptop systems, cellular telephones (e.g. smartphones and personal digital assistants (PDAs)), and portable devices designed specifically for playing audio and audiovisual content (e.g. the iPod®, MP3 players, and DVD players). The popularity of digital player devices such as the iPod® line of products, available from Apple, Inc. of Cupertino, Calif., and other digital player devices, such as MP3 players, has led to an increase in online music sales and a decrease in sales at traditional, brick-and-mortar music stores. Using the internet, consumers can purchase music files by the song or by entire albums at set prices, and then download the song/album digital file directly to a digital player device. A downloaded song digital file typically costs about $1, whereas a downloaded album digital file with multiple songs can cost around $10 or more.

Traditional media formats (e.g. tangible CDs and DVDs) for transferring audio content (e.g. music), audiovisual content (e.g. movies and television shows), software, and databases have some advantages over digital content files. For example, CDs and DVDs may be easily resold or transferred to another person to take advantage of the right to resell or transfer the particular work on the tangible CD or DVD. As a result, when the owner of a particular tangible CD or DVD is tired of listening to the particular music or watching the motion picture, there is a way to recoup the costs of purchasing the content, such as by reselling the tangible CD or DVD using the internet (e.g. using auction websites or an online community) to a brick-and-mortar music store that purchases used tangible CDs and DVDs and resells the tangible CDs and DVDs to others.

### BRIEF SUMMARY OF THE INVENTION

Unlike traditional media formats, a downloaded digital content file may not be easily resold or transferred to another person. Due to the ease with which digital content files may be illicitly copied without the permission of the copyright owner(s), such content is usually provided with copyright protection or encryption software that prevents the duplication of the digital content files. The owner of a particular digital content file is therefore unable to take advantage of the right to resell or transfer the particular work as can be done with a tangible CD or DVD. As a result, when the owner of a particular digital content file is tired of listening to the particular music or watching the motion pictures, there is no way to recoup the costs of purchasing the content.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

The present invention will be more fully understood and appreciated by reading the following Detailed Description in conjunction with the accompanying drawings, in which:

FIG. 1 is a schematic of the modules of an exemplary system according to the present invention.

FIG. 2 is a flowchart depicting an exemplary method of digital content resale and purchase according to the present invention.

FIG. 3 is a schematic of a file trading module according to the present invention.

### DETAILED DESCRIPTION OF THE INVENTION

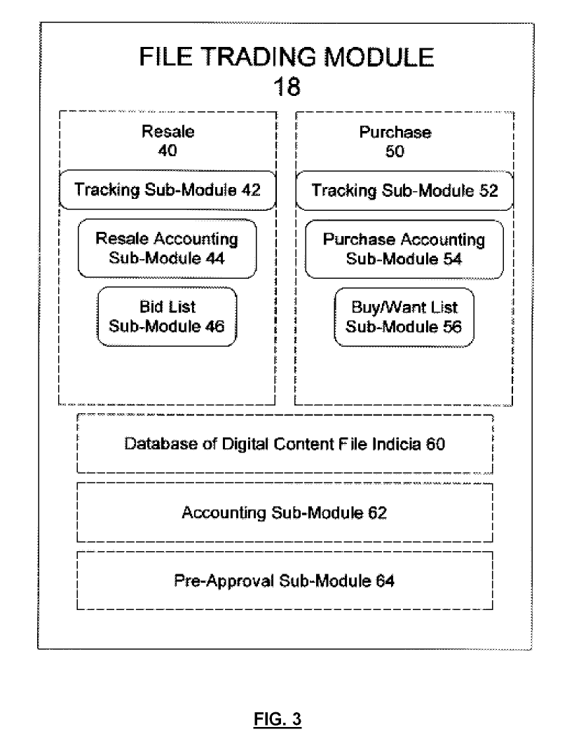

FIG. 3 is a flow chart illustrating methods and systems. It will be understood that each block of this flow chart, and combinations of blocks in this flow chart, may be implemented by computer program instructions. These computer program instructions may be loaded onto a computer (or the memory of the computer) to produce a machine, such that the instructions that execute on the computer create structures for implementing the functions specified in the flow chart block or blocks. These computer program instructions may also be stored in a memory that can direct a computer to function in a particular manner, such that the instructions stored in the memory produce an article of manufacture including instruction structures that implement the function specified in the flow chart block or blocks. The computer program instructions may also be loaded onto a computer to cause a series of operational steps to be performed on or by the computer to produce a computer implemented process such that the instructions that execute on the computer provide steps for implementing the functions specified in the flow chart block or blocks. Accordingly, blocks of the flow charts support combinations of structures for performing the specified functions and combinations of steps for performing the specified functions. It will also be understood that each block of the flow charts, and combinations of blocks in the flow charts, may be divided and/or joined with other blocks of the flow charts without affecting the scope of the invention.

The present invention relates to a digital content file reselling system 10 (“system 10”) and a digital content file reselling method 110 (“method 110”) that allow users using a user device 20 to resell and purchase downloadable digital content files 30. A user device 20, for purposes of the present invention, includes any type of digital player device. Digital content files 30, for purposes of the present invention, include audio digital content files (e.g. songs, albums, music, spoken word recordings), audiovisual digital content files (e.g. movies, television shows), and other types of “digital content” (e.g. software and databases). The term “resell,” for purposes of the present invention, includes any type of transfer of ownership or offer of transfer of ownership and includes, for example, selling, reselling, transferring, trading, swapping, donating, and/or offering for any of these purposes. The term “resell” is used in this description over the term “sell” because most transactions in the present invention will involve “used” or “secondhand” digital content files 30. The term “purchase,” for purposes of the present invention, includes any type of receipt of ownership or offer to receive ownership and includes, for example, buying, trading, swapping, receiving as a gift, and/or offering for any of these purposes. Users may be owners/resellers, purchasers, or both.

The system 10 and method 110 of the present invention allow the owner of a particular digital content file 30 to take advantage of the right to resell the particular work embodied on the digital content file 30 (as can be done with a tangible CD or DVD). As a result, when the owner of a particular digital content file 30 is tired of digitally utilizing the work embodied in the particular digital content file 30, the present invention provides a means for allowing the owner user to resell the digital content files 30 to a purchaser user. In some preferred embodiments of the present invention, the resale of the digital content files 30 is accomplished using the internet. In preferred embodiments of the present invention, the resale of the digital content files 30 is accomplished without creating illicit copies of copyrighted works.

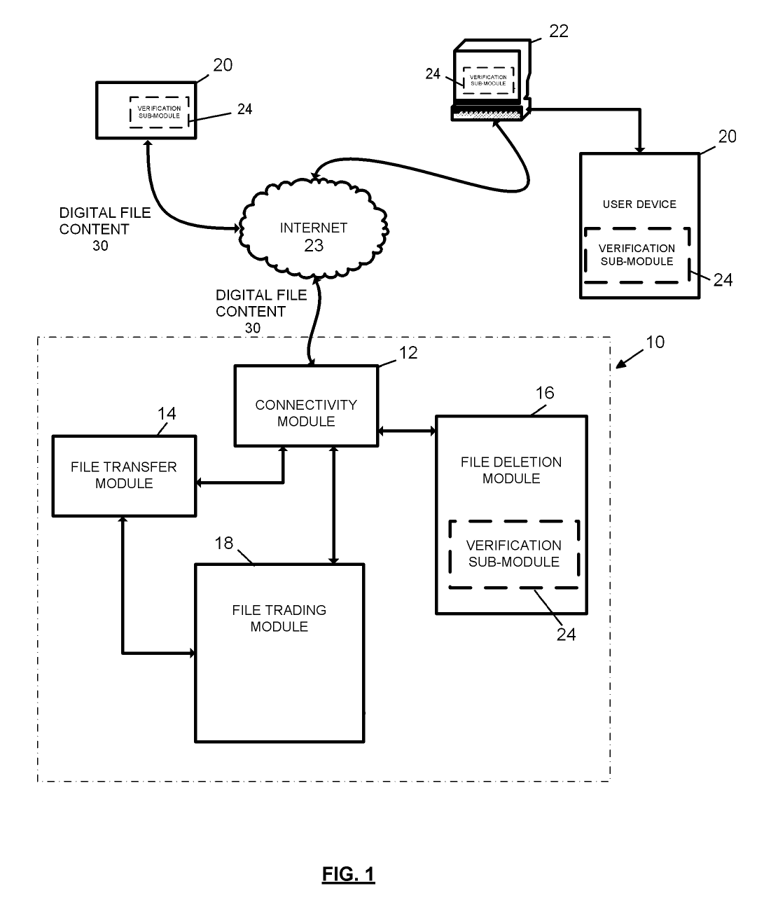

Referring now to the drawings, wherein like reference numerals refer to like parts throughout, FIG. 1 shows an exemplary online digital content file reselling system 10 including a connectivity module 12, a file transfer module 14, a file deletion module 16, and a file trading module 18, all of which may be programmed into a processing device (e.g. a computer or other internet access device) according to conventional methods. A user device 20 is a digital player device that may interconnect with system 10, either directly or indirectly through a user host device 22. In a preferred embodiment, system 10 is configured to be accessed by users through a communication network (referred to generally as the internet 23). The file deletion module 16 may further include a verification sub-module 24.

Summarily, the present invention provides an online file reselling system 10 that includes a connectivity module 12 programmed to allow remotely located users to access the system 10 via the internet 23. The file transfer module 14 is preferably programmed to allow remote users to transmit and receive digital content files 30 through the connectivity module 12. The system 10 also includes a file deletion module 16 programmed to ensure that no copies of the digital content files 30 transmitted and received by users are retained at the source. The file deletion module 16 may include a verification sub-module 24 that is downloadable by the user (e.g. as client software and/or as plug-ins) and resides on the user device 20 from which the digital content files 30 are provided, or to which the digital content files 30 are sent. The system 10 additionally includes a file trading module 18 for purchasing digital content files 30 and reselling used digital content files 30.

It should be recognized by those of skill in the art that the various modules described herein may be programmed or implemented in any number of fashions, and as discrete modules or as part of an integral system. For example, connectivity module 12, file transfer module 14, file deletion module 16, and file trading module 18 may be incorporated into a single program or provided as part of an enterprise system (e.g. a larger program or computer system). The modules of system 10 thus include functional elements that may be implemented through any number of known computer programming architectures.

Connectivity module 12 allows remotely located users to access the system 10 via the internet 23. It should be recognized by those of skill in the art that connectivity module 12 may include a conventional website having a URL allowing users to access system 10 through an internet browser directed to the particular address of the website. Connectivity module 12 may instead include an interface that may be accessed wirelessly, such as by cellular telephones, smartphones, or through other portable telephonic devices, such as personal digital assistants (PDAs).

File transfer module 14 allows users to transmit and receive digital content files 30 through connectivity module 12. File transfer module 14 is thus programmed to send and receive data through conventional transfer protocols, such as FTP, and can recognize various digital content files 30, such as MPEG, MPEG2, Windows Media Audio, Advanced Audio Coding, Adaptive Transform Acoustic Coding, MP3, executable files, and any other type of digitally encoded file. Other forms of digital content files 30 may be recognized and transferred by the present invention. For example, electronic licenses for the use of computer hardware, software, and the like may be transferred by the present invention, in conjunction or separately from the actual hardware or software.

File deletion module 16 verifies that no copies of the digital content files 30 transmitted or received by users are retained at the source. File deletion module 16 thus ensures that the owner of the digital content file 30 has in fact transferred the only existing copy of the digital content file 30 to which he has ownership rights, and has not retained any additional copies of the work. File deletion module 16 may further include a verification sub-module 24 that must be downloaded by the user (e.g. as client software and/or as plug-ins) to his user device 20 prior to using system 10.

Verification sub-module 24 resides on the user device 20 from which the digital content files 30 of the user will be provided, or to which the digital content files will be sent. Verification sub-module 24 is programmed to survey the user device 20 for illicit copies and destroy any retained copies of the content transferred to system 10 immediately after the user transfers a digital content file 30. Verification sub-module 24 may then transmit a signal or command to system 10 indicating that a proper transfer has been made, thereby allowing the user to be credited by system 10 for making the particular transfer. Verification sub-module 24 may be programmed to attach a serial number to each digital content file and preferably includes conventional encryption and protection techniques to preclude users from altering or changing the serial number. Verification sub-module 24 may be further programmed to create a list of digital content files on a particular user device 20 and delete any modified digital content files 30 that no longer correspond to the list.

File deletion module 16 or verification sub-module 24 may alternatively include a locking module that, instead of deleting transferred digital content files 30, locks the digital content file 30 from use by a user device 20 until the user re-purchases the digital content file 30 or establishes that that there has been an error in the transfer or targeting of the digital content file 30 for transfer. To provide additional protection, the file deletion module 16 may be programmed to crawl through the user device 20 and/or user host device 22 during times of disuse, such as nighttime or when devices 20, 22 are not used for a predetermined period of time, to locate any digital content files 30 that have transferred but not properly deleted. Similarly, file deletion module 16 or verification sub-module 24 may be programmed to locate digital content files 30 that have been tampered with, such as having a file name altered, to inhibit fraud. File deletion module 16 or verification sub-module 24 is preferably programmed to scan any attached user devices 20 at regular intervals or upon attachment of a user device 20 for illicit digital content files 30 and then lock or delete any such files.

File trading module 18 is programmed to track which digital content files 30 are uploaded to system 10 by an owner user, or downloaded by a purchaser user from system 10. For example, file trading module 18 may be programmed to generate a list of digital content files 30 available for purchase and provide it to connectivity module 12 for display to a user. Each digital content file 30 is made available for repurchase by another single user, and removed from the list of available content once it is purchased. In other words, system 10 does not allow an uploaded digital content file 30 to be resold to more than one other user.

To ensure the veracity of content, file trading module 18 may be programmed to include a database of additional digital content file 30 indicia, such as file size, digital fingerprint, or other identifying information for particular digital content files 30, against which a particular digital content file 30 that has been offered for a trade may be compared to verify that the digital content file 30 offered for resale is legitimate. In the event that identifying indicia is not available in such a database, system 10 can elect to place the offered content for resale, and if sold and verified as good by the purchaser, then pay the reseller, or have an individual associated with the management of system 10 verify the authenticity of a digital content file 30 for an additional charge. For example, a back office management employee can be provided with a queue of items to check by system 10 and then check each item, one after another, quickly (such as one check every fifteen seconds).

File trading module 18 may further include an accounting sub-module 62 that is programmed to track user account information and record the transactions made by particular users of system 10. It should be recognized by those of skill in the art that accounting sub-module 62 may include an online account established by a user and include personal information, such as a user name, password, account history, payment information (such as credit card data), mailing address, email address, etc. for establishing the identity of each user and allowing for commercial resales transactions.

File trading module 18 is further programmed to accept payment from a user for items selected by the user from the list of available content on system 10. File trading module 18 may be further programmed to provide a user with credit in accounting sub-module 62 for digital content files 30 transferred by the particular user to system 10, and then add any such digital content files 30 to the list of available content on system 10. File trading module 18 and accounting sub-module 62 of system 10 is preferably programmed to pay a user a first fixed amount for each digital content file 30 supplied to system 10, and charge a user a second, fixed amount for each digital content file 30 purchased to system 10. The first fixed amount is preferably a non-cash credit toward future purchases of available content by the user. A user may thus trade in multiple digital content files 30 and accumulate a credit toward the purchase of new content available from system 10. The second fixed amount is preferably a cash amount to be paid by the user. Payment may be effected by off-setting any credits against the amount due, and then charging the user for the difference, such as by accepting a credit card supplied by the user or using an electronic payment service, such as PayPal® available from eBay, Inc. of San Jose, Calif. For example, a user may receive a credit of $0.10 for each digital content file 30 transferred to system 10, and charged $0.50 for each digital content file 30 purchased from system 10. Alternatively, file trading module 18 may be configured to allow a user to send a digital content file 30 to another user as a gift, and charge a nominal fee to the user providing the gift.

File trading module 18 may require all users to provide adequate pre-approved payment information, such as credit card information, to protect against fraudulent sales of corrupt digital content files 30, unusable digital content files 30, illicit content, misnamed content, etc. Purchaser users may thus report fraudulent sales that may be subsequently investigated by the present invention and any refunds provided accordingly. Users of system 10 may receive a rating based on the number of successful trades, number of reports of fraudulent activity, etc. that may be viewed to help establish a reputation for a particular user. Such a rating system is based on objective data, such as the failure of a complaint to be registered within a predetermined time after a transfer, such as seven days.

File trading module 18 may alternatively be programmed to create a bid list containing digital content files 30 that a user wishes to transfer. The content may be viewed by other users of the system 10 of the present invention, who may then enter bids for the purchase of the digital content files 30. File trading module 18 may then extract a percentage of the bid amount in exchange for providing the bidding and transfer services.

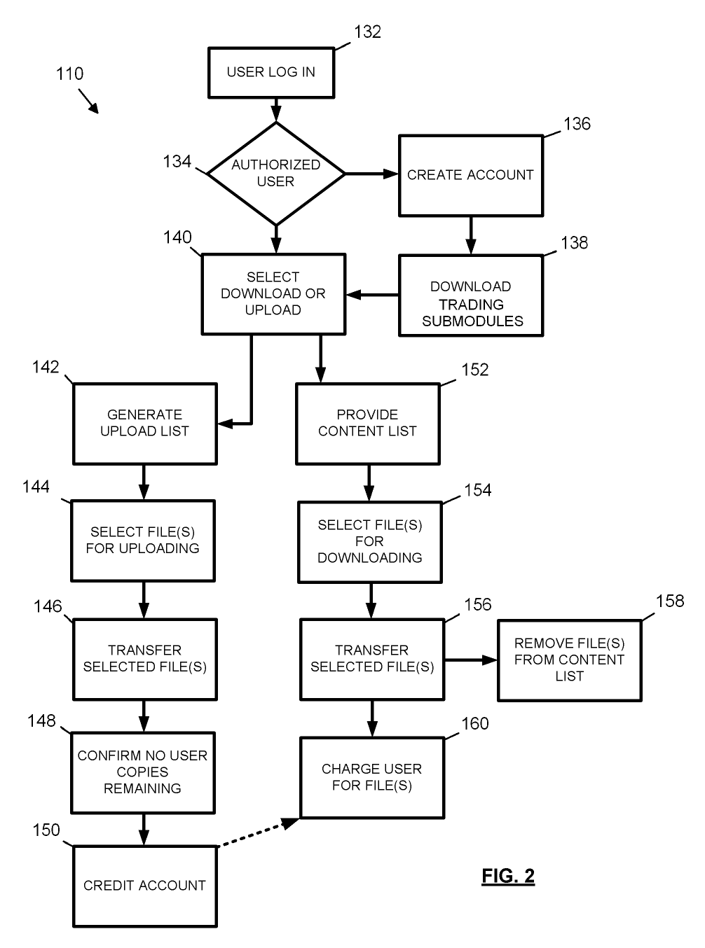

FIG. 2 depicts an exemplary method 110 of reselling (selling, transferring, trading, or swapping) used digital content files according to the present invention. The first step of method 110 involves a user logging into 132 or establishing a connection with system 10. A check is performed 134 to determine whether the user is authorized to use system 10. If the user is not a previously authorized user of system 10, the user is prompted to create a trading account 136 and enter any required personal information. The user may also be required to download one or more programs (modules) or sub-programs (sub-modules) 138 to the user's digital player device 20 and/or user host device 22 that are required for using system 10, such as verification sub-module 24. Once a user has established an account with system 10, or is found to have one at step 134, the user is allowed to choose whether he wants to download or upload digital content files 140.

If the user opts to upload digital content files 30 at step 140, system 10 communicates with the user's digital player device 20 to generate a list of available digital content files 30 for uploading 142 to system 10. Once the user has selected the digital content files 144 to resell to system 10, the digital content files 30 are transferred 146 to user device 20. Verification sub-module 24 then confirms 148 that no illicit copies remain on the user device 20. Once verification sub-module 24 confirms that the digital content file 30 was properly transferred and no copies remain, the user's account is credited 150 with the appropriate amount (funds).

If the user instead opts to download digital content files 30 at step 140, file trading module 18 provides the user with a list of available content 152. It should be recognized by those of skill in the art that the content may be sorted according to type of digital content file 30, such as an audio digital content file 30 or an audiovisual digital content file 30, or further sorted according to conventional genre classification, such as hard rock or popular for an audio digital content file 30 or action or comedy for an audiovisual digital content file 30. Alternatively, the user may include a designation or preferred content in his user profile, thereby pre-selecting what content will be presented. The user is then allowed to select content for downloading 154, and system 10 transfers the selected digital content files 156 to user device 20. At the same time, the system 10 removes the digital content files 30 from the content list 158, thereby preventing another user from transferring the same digital content file 30 and ensuring that no additional copies of the digital content files 30 are created. The user is then charged the appropriate amount 160, minus any existing credits in the user's account.

It should be recognized by those of skill in the art, that the steps of method 110 are not exhaustive and may be performed in other ways. For example, payment for digital content files 30 transferred from system 10 by a user may be obtained prior to the actual transfer of the digital content files 30. Another example is that method 110 may be used to transfer any form of digital content files 30.

What is claimed is:

1. A system for allowing an owner of a digital content file stored on a user device to resell said digital content file as a previously owned digital content file or for allowing a purchaser to purchase said previously owned digital content file, said system comprising:
a first module programmed to transfer said previously owned digital content file between said user device and said system;
a second module programmed to verify that no copies of said previously owned digital content file remain on said user device and no copies of said previously owned digital content file remain on said system.

2. The system of claim 1, wherein said second module resides at least in part on said user device.

3. The system of claim 2, further comprising a third module programmed to create a list of digital content files on said user device that are available for transfer.

4. The system of claim 3, wherein said third module is programmed to create a list of digital content files on said system available for transfer.

5. The system of claim 4, wherein said third module is programmed to allow said owner to select which digital content files are to be transferred.

6. The system of claim 5, further comprising a fourth module programmed to track the transfer of digital content files between said user device and said system.

7. The system of claim 6, wherein said fourth module is programmed to credit or charge said owner a predetermined amount based on the transfer of digital content files between said owner and said system.

8. The system of claim 7, wherein said fourth module is further programmed to obtain payment from said owner for charges associated with the transfer of digital content files between said owner and said system.

9. A method for allowing an owner of a digital content file to resell or purchase previously owned digital content files, comprising the steps of:
generating a list of digital content files available for transfer from a user device of said owner;
allowing said owner to select said digital content files to be transferred from said user device;
transferring said selected digital content files from said user device;
confirming that no copies of said transferred digital content files are retained on said user device; and
providing said owner with compensation for said transferred digital content files.

10. The method of claim 9, further comprising the steps of:
generating a list of digital content files available for transfer to said user device of said owner;
allowing said user to select said digital content files to be transferred to said user device;
transferring said selected digital content files to said user device of said owner;
confirming that no copies of said transferred digital content files are retained; and
obtaining compensation from said owner for said transferred digital content files.

11. The method of claim 10, wherein the step of confirming that no copies of said transferred digital content files are retained by said owner comprises scanning said user device for copies of said transferred digital content files.

12. The method of claim 11, wherein the step of providing said owner with compensation for said transferred digital content files comprises providing said owner with a predetermined amount of credit in an account.

13. The method of claim 11, wherein the step of obtaining compensation from said owner for said transferred digital content files comprises completing a payment transaction.

14. The method of claim 12, wherein the step of obtaining compensation from said owner for said transferred digital content files further comprises offsetting amounts due with credit in said account of said owner.
